(19) United States
(12) Patent Application Publication
(10) Pub. No.: US 2007/0143762 A1
(43) Pub. Date: Jun. 21, 2007

(54) Assigning tasks in a distributed system based on ranking

(76) Inventors: Kevin M. Arnold, Los Gatos, CA (US); David Kramer, Santa Clara, CA (US)

Correspondence Address: WILLIAMS, MORGAN & AMERSON, 10333 RICHMOND, SUITE 1100, HOUSTON, TX, 77042, US

(21) Appl. No.: 11/303,105

(22) Filed: Dec. 16, 2005

(51) Int. Cl. G06F 9/46

(52) U.S. Cl. 718/103

(57) ABSTRACT

A method and apparatus are provided for selecting a remote system suitable to process one or more tasks. The method includes transmitting a utility to a plurality of remote systems; receiving ranking values generated by the execution of the utility by each of the plurality of remote systems; and selecting a remote system from the plurality of remote systems to process the task based on the received ranking values.

### BACKGROUND OF THE INVENTION

1. Field of the Invention

The invention generally relates to assigning tasks for processing in a distributed system, and, in particular, to assigning tasks based on a ranking associated with available resources.

2. Description of the Related Art

Distributed computing has become increasingly popular with the maturation of network technology. Oftentimes, it is desirable to exploit the processing power of various networked machines that may otherwise be idle or under utilized. For instace, it may be desirable to use the processing power of the networked machines to compute computationally taxing tasks, such as image processing or rendering, audio processing, video processing, encrypting, decrypting, or the like. One example of a distributed computing architecture is Xgrid™ (Version 1.0) provided by Apple Computer, Inc.

In a typical disturbed computing environment, a central machine on a network divides a project into a number of tasks, which are assigned to one or more of the networked machines for processing or manipulation. The results are then returned to the central machine once the processing is complete.

There are several conventional ways of assigning tasks to volunteer machines. First, tasks may be delegated to pre-determined volunteer machines using a circular, round-robin scheme. In this round-robin approach, incoming tasks are assigned to volunteer machines on a rotating basis in the order those machines are in a list. Second, tasks may be delegated to volunteer machines based on limited information received from these machines regarding their operational capabilities (e.g., processor speed).

Both of these ways can be costly in terms of overhead, and can often produce inefficient results. A round-robin scheme is not particularly efficient for delegating tasks because of the potential mismatch between the amount of work load that is assigned to a particular volunteer machine and its processing capabilities. For example, based on a round-robin scheme, a client machine may delegate a task to a slower, less capable volunteer machine instead of another faster volunteer machine, simply because the slower machine is next in line to receive the task. Similarly, the tasks may be routinely delegated to a volunteer machine that is presently overloaded over an under-utilized volunteer machine based simply on the relative positions of the two volunteer machines in the round-robin scheme.

Like the round-robin scheme, the other scheme (where the controller selects a volunteer machine based on that's machine particular resource capability) also tends to be inefficient and inflexible. This is because the same, fixed criteria (such as speed of the processor) is used to assign tasks to volunteer machines, regardless of nature of the tasks that need to be assigned. For example, a graphics-intensive task that can be more readily processed by a particular graphics card may be assigned to a machine with a faster processor but not the desired graphics card. Similarly, other tasks to be assigned that may not necessarily be suited for volunteer machines that have been identified based on fixed criteria.

Thus, there is a need to efficiently delegate tasks in distributed compilation systems. The present invention is directed to overcoming, or at least reducing, the effects of, one or more of the deficiencies set forth above.

### SUMMARY OF THE INVENTION

In one aspect of the instant invention, a method is provided for selecting a remote system suitable to process one or more tasks. The method includes transmitting a utility to a plurality of remote systems; receiving ranking values generated by the execution of the utility by each of the plurality of remote systems; and selecting a remote system from the plurality of remote systems to process the task based on the received ranking values.

In another aspect of the instant invention, an apparatus is provided for selecting a remote system suitable to process one or more tasks. The apparatus includes an interface and a control unit. The control unit is adapted to transmit a utility to a plurality of remote systems; receive ranking values generated by the execution of the utility by the plurality of remote systems; and determine one or more remote systems suitable to process a task based on the received ranking values.

In yet another aspect of the instant invention, an article comprising one or more machine-readable storage media containing instructions is provided for selecting a remote system suitable to process one or more tasks. The instructions, when executed, enable a processor to transmit a utility to a plurality of remote systems; receive ranking values generated by the execution of the utility by the plurality of remote systems; and determine one or more remote systems suitable to process a task based on the received ranking values.

In yet another aspect of the instant invention, a distributed compilation system is provided for selecting a remote system suitable to process one or more tasks. The system includes a plurality of remote systems and a controller system. The controller system is adapted to transmit a utility to the plurality of remote systems; receive ranking values generated by the execution of the utility by the plurality of remote systems; and determine one or more remote systems suitable to process a task based on the received ranking values.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a distributed compilation system, in accordance with one embodiment of the present invention;

FIG. 2 is a block diagram of a client system, a controller system, and/or remote system that may be employed in the distributed system of FIG. 1, in accordance with one embodiment of the present invention; and

FIG. 3 is an illustration of a flow diagram of a rating module executing on the controller system of FIG. 2, in accordance with one embodiment of the present invention; and

FIG. 4 is an illustration of a flow diagram of a delegating module executing on the controller system of FIG. 2, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

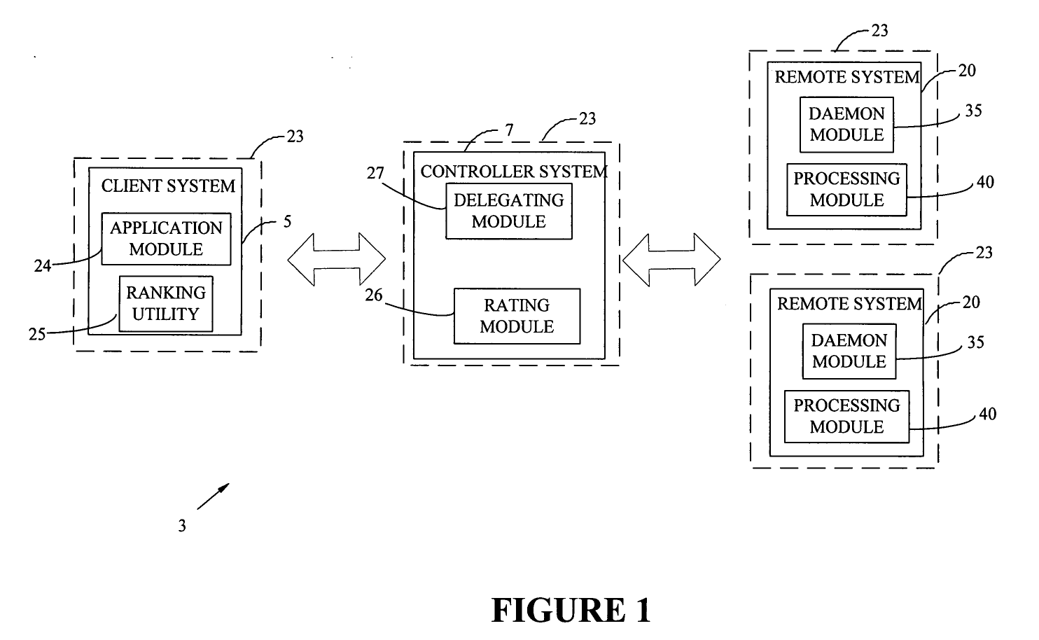

Referring to FIG. 1, a distributed system 3 includes a plurality of systems, such as a client system 5, a controller system 7, and remote systems 20, in which tasks may be assigned to one or more of the remote systems 20 by the client system 5 via the controller system 7. The types of tasks that are assigned to the remote systems 20 by the client system 5 may vary, depending on the implementation, and may include, but not be limited to, image processing or rendering tasks, audio processing tasks, video processing tasks, encrypting tasks, decrypting tasks, compilation tasks, or other computationally intensive tasks.

In the illustrated embodiment, the client system 5 provides a task requiring processing to the controller system 7, which may then split the task into one or more sub-tasks and submit them to one or more of the remote systems 20. The remote systems 20, upon executing the tasks or sub-tasks, provide the results to the controller system 7, which then provides the results to the client system 5. Although one client system 5 is illustrated in the distributive system 3 of FIG. 1, it should be appreciated that the distributive system 3 may include a plurality of client systems 5 that submit request tasks to the controller system 7 for processing.

As utilized herein, the term “client” refers to an application (or routine) executing on a system that delegates one or more tasks to other systems for completion. For ease of illustration, the system 5 is designated as the “client” in FIG. 1, although it should be appreciated that any of the remote systems 20 may also be configured as a “client” so that it is able to delegate tasks to the other remote systems 20. Thus, the roles of client and remote systems 5, 20 may vary over time in that the various systems may occasionally take on the role of client and at other times operate as a remote system. It may also be possible that, in some instances, a given system 5, 20 performs a dual role of a client system and a remote system by assigning tasks to other systems 5, 20 and, at substantially the same time, performing tasks for the other systems 5, 20.

It should be appreciated that the three-system configuration (which includes the client, controller, and remote systems 5, 7, and 20) shown in FIG. 1 is exemplary, and that in alternative embodiments, other configurations may be used without deviating from the spirit and scope of the present invention. For example, in an alternative embodiment, the functionality of these systems 5, 7, and 20 can be combined or merged with one another. For instance, in one embodiment, the client system 5 may perform the role of the client system 5 as well as the controller system 5. As such, this configuration would include a client system 5 that communicates with the remote systems 20 without a separate, intermediary controller system 7.

The client system 5, the controller system 7, and remote systems 20, in one embodiment, can be coupled to each other by a data network (not shown), which may be a public or a private network. Examples of the data network may include local area networks (LANs), wide area networks (WANs), intranets, the Internet, or the like. The data network may be a packet-switched data network, such as a data network according to the Internet Protocol (IP). A “data network” may refer to one or more channels, links, or paths, and systems or devices (such as routers) used to route data over such networks, channels, links, or paths. If desired, client system 5 and controller system 5 may, in one embodiment, may multicast data packets to the remote systems 20.

The systems 5, 7 and 20 may be any processor-based systems, such as computers in the form of desktops, laptops, mainframes, personal digital assistants, or the like. In one embodiment, the systems 5, 7, 20 may be located at various locations 23, which may be representative of different departments or centers of an organization, or, alternatively, different offices of an organization. Thus, for example, the locations 23, in one embodiment, may represent different offices/centers within a building, within one or more building complexes, within a city or country, or the like.

As described below, in accordance with one embodiment of the present invention, the controller system 7 associates ranking information with the plurality of remote systems 20, and this ranking information is then utilized to identify remote systems 20 that are suitable to process task(s) provided by the client system 5. In general, remote systems 20 are “ranked” based on a ranking utility associated with a task. The ranking utility, which may be an executable routine or a runnable script, includes a criteria (or algorithm) that determines if the remote system 20 is adequately equipped with resource(s) to perform the task provided by the client system 5. The criteria may be based on definitive criteria (such as hardware configuration of a remote system 20), more fluid criteria (such as the operational load of the remote system 20 at a given time), or a combination of both. The assigner of the task selects the criteria that are pertinent to the task at issue such that the remote systems 20 that match closest to the criteria will have a higher rank relative to those that do not. In one embodiment, the ranking values can be scaled (e.g., scaled to a range between 0 to 100, with 100 being the highest ranking, or vice-versa).

As noted, the generated ranking values of the various remote systems 20 can then be utilized to determine which of the remote systems 20 are suitable to assist with processing the submitted task provided by the client system 5. In one embodiment, aside from generating a ranking value, the ranking utility may also provide additional information (referred to as “metadata” herein) about the ranking value or the remote system 20. For example, in addition to the ranking value, the ranking utility may indicate variety of information about the remote system 20, such as the amount of configured memory (e.g., 12 gigabytes), which version of the relevant software is installed, the level of processor speed (e.g., 3 gigahertz), or the like. In other embodiments, the metadata can indicate if the resources of the remote system 20 exceed at threshold value, such as whether the configured memory exceeds a certain threshold, whether the amount of available hard disk space is at least a certain specified value, whether the processor speed is about a selected value, or the like. This metadata, in one embodiment, can be used to further refine which remote systems 20 are better suited than other qualified systems to perform the task to be assigned.

One or more embodiments of the present invention allow an assignor of a task (such as the client system 5, in this case) to efficiently and effectively identify and assign tasks to one or more remote stations 20. This is because the task assigner has the option to define its own criteria to identify remote systems 20 that are better equipped to process the task at hand. Moreover, because the defined criteria can be embodied in a ranking utility that can be executed by the remote machines 20, the task assignor need not know in advance the configuration of the remote systems 20; rather, this information can be obtained when the ranking utility is executed by the remote systems 20. Additionally, the use of the ranking utility also makes it possible to collect up-to-date configuration information (or the current conditions) of the remote machines 20.

In the illustrated embodiment, the client system 5 includes an application module 24 that provides one or more tasks to the controller system 7 to delegate to the qualified remote systems 20. In one embodiment, the application module 24 also provides at least one ranking utility 25 that each remote system 20 can execute to generate its ranking value. The ranking value can be used to determine whether a given remote system 20 is suitable to participate in the execution of tasks. In one embodiment, the client system 5 may include more than one ranking utility, each embodying an algorithm or criteria useful in identifying remote systems 20 that are suitable to perform tasks assigned by the client system 5.

In the illustrated embodiment, the client system 5 transmits the ranking utility 25 to the controller system 7, which in turn manages the distribution of the utility 25 to the remote systems 20. In an alternative embodiment, the client system 5 may transmit its ranking utility 25 to one or more of the remote systems 20 without an intervening controller system 7. The manner in which the ranking utility 25 is provided to the remote systems 20 is implementation specific, and thus can vary based on the designer's desires or goals. In some instances, the ranking utility 25 may be preinstalled or manually installed on the remote systems 20 and thus it may not be necessary to transmit a copy of the ranking utility 25.

As noted, the application module 24 of the client system 5 provides one or more tasks that require completion. In one embodiment, in connection with submitting task(s), the application module 24 of the client system 5 also provides an identifier to the controller system 7. The identifier specifies the particular requirements of processing the task. For example, the identifier may indicate the ranking utility that is associated with the incoming task so that the appropriate ranking values can be utilized to determine which remote stations 20 are suitable to participate in the execution of the submitted task.

In the illustrated embodiment, the controller system 7 includes a rating module 26 that determines the ranking of the various remote systems 20 based on the ranking utility 24 provided by the client system 5. The controller system 7 also includes a delegating module 27 that assigns tasks (or sub-tasks) to the remote systems 20 based on the determined ranking values of the remote systems 20.

In the illustrated embodiment of FIG. 1, the remote systems 20 include a daemon module 35, which executes on the remote systems 20, and responds to requests from the client system 5. For example, the daemon module 35 accepts the ranking utility 25 from the controller system 7, executes that ranking utility 25, and provides the results (e.g., ranking value) to the controller system 7. Although not shown, in one embodiment, the client system 5 may also include the daemon module 35.

In the illustrated embodiment, the daemon module 35 utilizes a processing module 40 executing on the remote system 20 to complete the tasks that are assigned to the remote system 20. In the context of a graphics-based task, the processing module 40 performs the appropriate calculations and provides the results to the controller system 20, which in turn can provide the results to the application module 24 of the client system 5. As an additional example, in the context of a code compilation task, the processing module 40 may, for example, compile one or more source files to produce object code files, link files with object code segments to produce executable files, perform pre-processing tasks, assemble files, or the like, and then provide the results for the client system 5.

The application module 24, rating module 26, delegating module 27, daemon module 35, and processing module 40, in the illustrated embodiment, are implemented in software. While these modules 24, 26, 27, 35, and 40 are illustrated as four distinct modules for the purposes of this discussion, it should be appreciated that some or all portions of these modules may be combined or expanded into any number of module(s). The modules 24, 26, 27, 35, and 40 in the illustrated embodiment are executable on the systems 5, 7, and 20, each of which may be, for example, a laptop computer, a desktop computer, a mainframe computer, a handheld device, or any other processor-based system capable of executing instructions. In alternative embodiments, some or all portions of one or more of these modules 24, 26, 27, 35, 40 may be implemented in hardware or firmware.

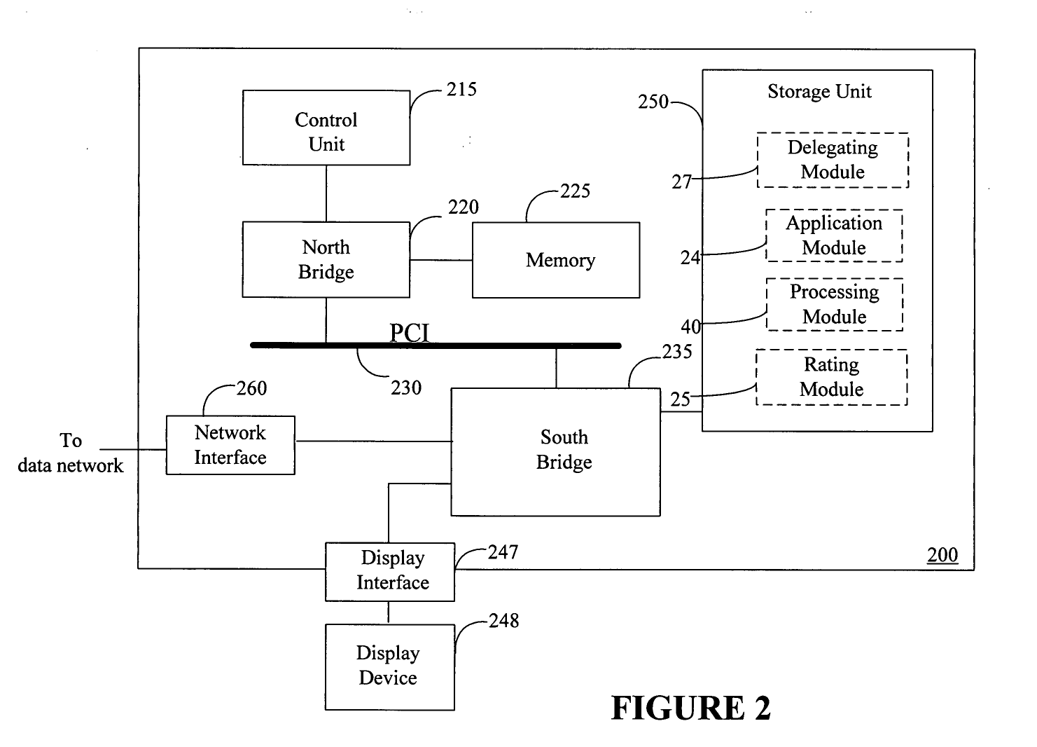

Referring now to FIG. 2, a stylized block diagram of a system 200 is illustrated, in accordance with one embodiment of the present invention. The system 200 may be implemented as the client system 5, controller system 7, and/or remote systems 20 of FIG. 1. The system 200 comprises a control unit 215, which in one embodiment may be a processor, and is capable of interfacing with a north bridge 220. The north bridge 220 provides memory management functions for a memory 225, as well as serves as a bridge to a peripheral component interconnect (PCI) bus 230. In the illustrated embodiment, the system 200 includes a south bridge 235 coupled to the PCI bus 230.

A storage unit 250 is coupled to the south bridge 235. A variety of modules, such as the application module 24, rating module 26, delegating module 27, daemon module 35, and processing module 40, may be stored in the storage unit 250 and executed by the control unit 215. Additionally, the ranking utility 25 may also be stored in the storage unit 250. Although not shown, it should be appreciated that in one embodiment an operating system, such as Windows®, Disk Operating System®, Unix®, Linux®, MAC OS®, or the like, may be stored on the storage unit 250 and executable by the control unit 215. The storage unit 250 may also include device drivers for the various hardware components of the system 200.

In the illustrated embodiment, the system 200 includes a display interface 247 that is coupled to the south bridge 235. The system 200 may display information on a display device 248 via the display interface 247. The south bridge 235 of the system 200 may include a controller (not shown) to allow a user to input information using an input device (not shown), such as a keyboard and/or a mouse.

The south bridge 235 of the system 200, in the illustrated embodiment, is coupled to a network interface 260, which may be adapted to receive, for example, a local area network card. In an alternative embodiment, the network interface 260 may be a Universal Serial Bus interface or an interface for wireless communications. The system 200 communicates with the remote system 20 coupled to a data network through the network interface 260.

It should be appreciated that the configuration of the system 200 of FIG. 2 is exemplary in nature and that, in other embodiments the system 200 may include fewer, additional, or different components without deviating from the spirit and scope of the present invention. For example, in an alternative embodiment, the system 200 may not include a north bridge 220 or a south bridge 235, or may include only one of the two bridges 220, 235, or may combine the functionality of the two bridges. As another example, in one embodiment, the system 200 may include more than one control unit 215. Similarly, other configurations may be employed consistent with the spirit and scope of the present invention.

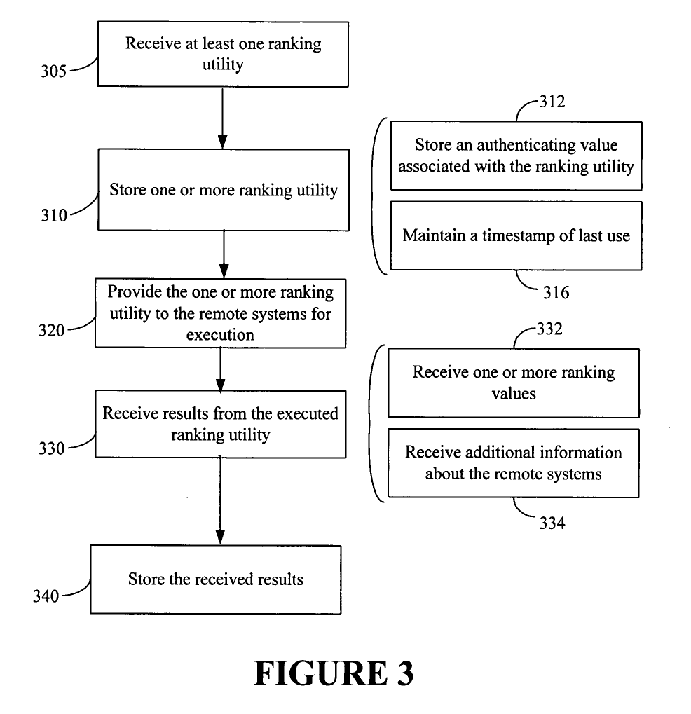

Referring now to FIG. 3, a flow diagram of one or more acts that are performed by the rating module 26 of the controller system 7 is illustrated, in accordance with one embodiment of the present invention. In particular, FIG. 3 illustrates one embodiment of a method for identifying the remote stations 20 that are suitable to perform the task(s) submitted by the client system 5. As noted earlier, the ranking values are calculated when the remote stations 20 execute the ranking utility provided by the client system 5. It should be appreciated that, in one embodiment, the client system 5 may provide the ranking utility 25 to the controller system 7 contemporaneously with the task it needs completed, or, alternatively, provide it separately from the task. For ease of illustration, it is assumed that in FIG. 3, the client system 5 provides the ranking utility 25 in advance of the task.

In FIG. 3, the rating module 26 of the controller system 7 receives (at 310) at least one ranking utility 25 (or a copy of the ranking utility 25) from the application module 24 of the client system 5. It should be appreciated that, in one embodiment, a plurality of client systems 5 may each transmit its own ranking utility (or utilities) to the controller system 7. Thus, at any given time, the controller system 7 may be handling a plurality of ranking utilities from a plurality of sources. However, for ease of illustration, it is assumed that one client system 5 transmits the ranking utility 25 (or utilities) to the controller system 7. It should be appreciated that, in one embodiment, the client system 5 may transmit a plurality of different ranking utilities 25 to the controller system 7.

The rating module 26 of the controller system 7 stores (at 310) the received ranking utility 25. The act of storing the received ranking utilities may include storing (at 312) an authenticating value associated with each of the ranking utilities. This authenticating value may be utilized to determine if the previously-stored ranking values are still valid. For example, if the authenticating value of a newly received ranking utility matches that of a previously received ranking utility, then that is an indication that the ranking values collected based on the previously received ranking utility are still valid. As such, the rating module 26 of the controller system 7 need not collect any new ranking values and need not overwrite the previously-received ranking utility. The authenticating value, in one embodiment, may be a hash value or a checksum value for allowing comparison of newly received ranking utility to a previously stored ranking utility.

As part of storing (at 310) the received ranking utility, the rating module 26 of the controller system 7 may also store (at 316) a timestamp of the last time a client system 5 submitted a task to the controller system 7 so that any previously-submitted, older ranking utilities can be removed after some period of idleness. In one embodiment, the rating module 26 updates the timestamp associated with the ranking utility each time the ranking values associated with the ranking utility are used to identify suitable remote stations 20 for processing a received task.

The rating module 26 of the controller system 7 provides (at 320) the received ranking utility 25 (or a copy of the ranking utility 25) to the one or more available remote systems 20 for execution. In an alternative embodiment, the rating module 26, if the controller system 7 receives a plurality of different ranking utilities from the client system 5, may be provide these ranking utilities to the remote systems 20. In one embodiment, the controller system 7 provides the ranking utility 25 to the remote systems 20 as the systems become available or otherwise establish a communication link with (or bind to) the controller system 7. In an alternative embodiment, the rating module 26 of the controller system 7 may multicast a notification to the remote systems 20, which may be communicatively linked to the controller system 7 via a data network, that a ranking utility is available. In a multicasting embodiment, the controller system 7 announces to a router (not shown) that a ranking utility is available for transmission. The router in turn multicasts the announcement to the available nodes or remote systems 20 based on the remote systems 20 identified in a multicast group or distribution list. The remote systems 20, in response to receiving the notification, can retrieve the ranking utility 25. In one embodiment, the router may dynamically update the contents of its multicast group. That is, as remote systems 20 become available or inaccessible, the router updates its multicast group accordingly. In one embodiment, the multicast group or distribution list may contain destination addresses associated with each of the remote systems 20 included in the group or list. The router, in one embodiment, may substantially simultaneously indicate to the available remote systems 20 regarding the availability of task(s). In one embodiment, the router may multicast the task notification to each of the available remote systems 20 using an efficient routing path.

Upon reception of the ranking utility, each of the remote systems 20 can execute its ranking utility 25 and provide the resulting ranking value to the controller system 7. The rating module 26 of the controller system 7 receives (at 330) results from the remote systems 20 that execute the ranking utility 25. The results returned will depend on the criteria specified in the ranking utility 25. In one embodiment, the results received will include the ranking value (see block 332) from the remote systems 20. In an alternative embodiment, the results received may also include metadata (see block 334) about the ranking value or the remote systems 20. The rating module 26 of the controller system 7 stores (at 340) the results that are received. These stored results can be utilized to delegate tasks to the remote systems 20, as described below.

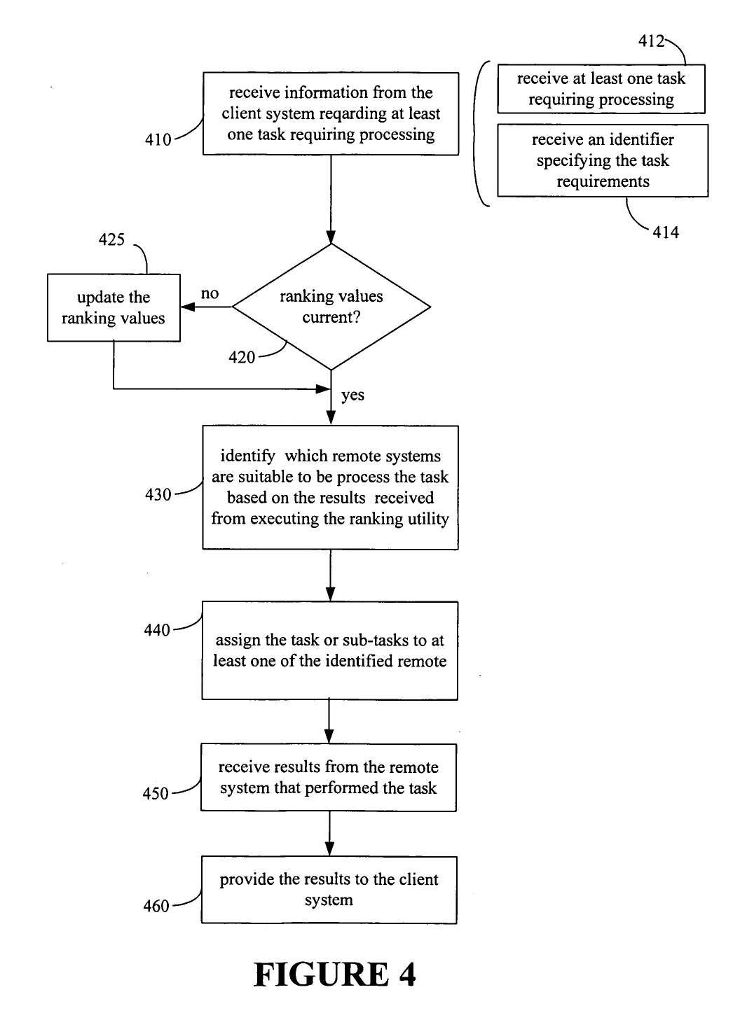

FIG. 4 illustrates a flow diagram of the delegating module 27 of the controller system 7 for assigning task(s) to the remote system 20, in accordance with one embodiment of the present invention. For ease of illustration, it is assumed that the controller system 7 has previously obtained the ranking values from the various remote systems 20 in the distributed system 3 of FIG. 1. One manner of obtaining the raking values is described above in connection with FIG. 3.

In FIG. 4, the delegating module 27 receives (410) information regarding at least one task requiring processing from the application module 24 of the client system 5. In one embodiment, the received information may include information about the task itself (see block 412). In one embodiment, the received information may also include an identifier (see block 414) that specifies the requirements for processing the task. For example, the identifier may indicate that the ranking values generated using a particular ranking utility should be used when determining which of the remote systems 20 are qualified to process the received task. In one embodiment, the identifier may indicate that ranking values from two or more ranking utilities should be combined in determining remote systems 20 that are suitable to process the received task.

The delegating module 27 determines (at 420) if the ranking values that are to be used are current or valid. The ranking values may not be valid for one of a variety reasons. For example, the lifetime of the ranking values may have expired such that they may not reflect current conditions of the remote systems 20. This may be particularly true for ranking values that are based on transient characteristics such as a remote system's current load or the quality of a network connection to that remote system. Another reason the ranking values may not be valid is if the ranking utility 125 that was executed to generate these values is outdated (either because a newer ranking utility has been received or because the lifetime of that ranking utility has expired). Similarly, there may be other reasons the ranking values may no longer be current or valid. In FIG. 4, if it is determined (at 420) that the ranking values are not current, the delegating module 27 updates (at 425) the ranking values. These values may be updated, for example, by requiring the remote stations 20 to execute the ranking utility 125 and provide the updated ranking values.

If it is determined (at 420) that the ranking values stored on the controller system 7 are current or valid, or if the invalid ranking values have been updated (at 425), the delegating module 26 identifies (at 430) which remote systems 20 are suitable or qualified to process the received task based on the results received from the execution of the ranking utility by the remote systems 20 (see blocks 330, 332, and 334 of FIG. 3). As shown in block 330-334 of FIG. 3, the results may include the ranking value, as well as metadata associated with that ranking value. Thus, in one embodiment, the delegating module 26 may determine that that only those remote stations 20 having a ranking value above a selected threshold level are qualified to process the task.

In another embodiment, the ranking value and the associated metadata may both be utilized to identify which of the remote systems 20 qualify to process the received task. For example, the delegating module 26 may initially use the ranking value to identify a select number of remote systems 20 that are qualified to process the received task. From this initial group of remote systems 20, the delegating module 26 may further narrow the number of qualifying remote systems 20 based on the received metadata. For instance, assuming that the metadata returned by each of the remote systems 20 related to the amount of available memory (e.g., 12 gigabytes) in that remote system 20, then only those remote systems 20 that have requisite amount of available memory would be qualified to execute the task. It should be appreciated that the ‘memory’ metadata example provided herein is illustrative only, and that, in alternative embodiments, any variety type of metadata may be employed to allow the task assignor greater flexibility in identifying suitable remote systems 20 to process the task.

Once the remote systems 20 that are suitable to perform the task have been identified (at 430), the delegating module 26 assigns (at 440) the task to at least one of the identified remote system 20. If the entire task is to be assigned to a single remote system 20, the delegating module 26 may select, for example, the remote system 20 with the highest ranking value among the qualifying remote systems 20. If the task is to be broken into several sub-tasks, the delegating module 26 may select, for example, from among those qualifying remote systems 20 that have the highest ranking values.

Once the task or sub-tasks are assigned, the responsible remote stations 20 execute the assigned task (or sub-task) and return the results to the delegating module 26 of the controller system 7. The delegating module 26, upon receiving (at 450), provides (at 460) the results to the application module 24 of the client system 5.

The foregoing description describes one or more embodiments for efficiently and effectively identifying one or more remote systems 20 in a distributed system 3 that are better suited to perform task(s) needing completion. In one illustrated embodiment, the task submitter is allowed to specify criteria in the form of a ranking utility that, when executed by each remote system 20, returns a ranking value for that remote system 20. The ranking value provides a basis to determine which of the remote systems 20 are adequately equipped to handle the task being assigned. Thus, one or more embodiments of the present invention allow the task submitter to specify prerequisite conditions for performing a task and allow the remote systems 20 to indicate by way of a ranking utility as to whether the systems meet those conditions. The use of the ranking utility also provides the task submitter a dynamic way to determine current (or up-to-date) operating conditions (e.g., available memory, network latency to a particular server or disk, etc.) of the remote systems 20 that are available to assist with processing the task.

Those skilled in the art will appreciate that the various system layers, routines, or modules illustrated in the various embodiments herein may be executable control units (such as the control unit 215 (see FIG. 2)). The control unit 215 may include a microprocessor, a microcontroller, a digital signal processor, a processor card (including one or more microprocessors or controllers), or other control or computing devices. The storage devices 250 referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 215 causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
transmitting a copy of a utility to a plurality of remote systems;
receiving ranking values generated by the execution of the utility by each of the plurality of remote systems; and
selecting a remote system from the plurality of remote systems to process the task based on the received ranking values.

2. The method of claim 1, wherein selecting the remote machine comprises selecting the remote system having the highest ranking value among the plurality of remote systems.

3. The method of claim 1, wherein the utility comprises at least one of an executable routine and runnable script, further comprising causing the selected remote system to process the task and receiving results from the processing of the task.

4. The method of claim 3, wherein the task comprises at least one of a compilation task, video processing task, audio processing task, image processing task, encryption task, and decryption task, and wherein transmitting the copy of the utility comprises transmitting a copy of a first utility to at least one of the plurality of remote systems and a copy of a second, different utility to at least another one of the plurality of remote systems.

5. The method of claim 1, wherein the ranking values have an associated lifetime, further comprising deleting the ranking values after the expiration of the lifetime.

6. The method of claim 1, further comprising:
transmitting a second utility to the plurality of remote systems;
receiving the second ranking values generated by the execution of the utility by each of the plurality of remote systems; and
selecting the remote system from the plurality of remote systems to process the task based on the received second ranking values.

7. The method of claim 3, wherein transmitting the utility comprises:
receiving, at the controller system, the utility from a client system;
transmitting the utility from the controller system to the plurality of remote systems; and
providing the results from the processing of the task to the client system.

8. The method of claim 7, wherein receiving the utility from the client system comprises receiving an authenticating value associated with the utility, where the authenticating value can be utilized to determine if received utility is different from a subsequently received utility.

9. The method of claim 7, wherein selecting the remote system comprises:
receiving, at the controller system, the task from the client system;
receiving, at the controller system, an identifier associated with the task; and
selecting the remote system to process the task based on the received task.

10. The method of claim 1, further comprising receiving information associated with at least one configuration aspect of the remote systems, and wherein selecting the remote system comprises selecting the remote system to process the task based on the received information associated with the configuration aspect of the remote systems.

11. The method of claim 10, wherein the information associated with the configuration aspect of the remote systems comprises information relating to at least one of a processing speed, memory size, network speed, and load level of the remote systems.

12. An article comprising one or more machine-readable storage media containing instructions that when executed enable a processor to:
transmit a utility to a plurality of remote systems;
receive ranking values generated by the execution of the utility by the plurality of remote systems; and
determine one or more remote systems suitable to process a task based on the received ranking values.

13. The article of claim 12, wherein the instructions when executed enable the processor to assign the task to at least one of the determined remote systems, to allow the task to be processed by the at least one determined remote systems, and to receive results from the processing of the task.

14. The article of claim 12, wherein the instructions when executed enable the processor to select the remote system having the highest ranking value among the plurality of remote systems.

15. The article of claim 12, wherein the instructions when executed enable the processor to cause the selected remote system to process the task and receiving results from the processing of the task.

16. The article of claim 12, wherein the instructions when executed enable the processor to:
receive, at a controller system, the utility from a client system;
transmit the utility from the controller system to the plurality of remote systems; and
provide the results from the processing of the task to the client system.

17. The article of claim 16, wherein the instructions when executed enable the processor to:
receive, at the controller system, the task from the client system;
receive, at the controller system, an identifier associated with the task; and
select the remote system to process the task based on the received task.

18. The article of claim 10, wherein the instructions when executed enable the processor to multicast a request to the plurality of remote systems coupled to a network that the task is available for processing.

19. An apparatus, comprising:
an interface adapted to communicate with a plurality of remote systems; and
a control unit communicatively coupled to the interface, the control unit adapted to:
transmit a utility to the plurality of remote systems;
receive ranking values generated by the execution of the utility by the plurality of remote systems; and
determine one or more remote systems suitable to process a task based on the received ranking values.

20. The apparatus of claim 19, wherein the control unit is adapted to multicast the utility to the plurality of remote systems.

21. The apparatus of claim 20, wherein the control unit is adapted to assign the task to at least one of the determined remote systems, to allow the task to be processed by the at least one determined remote systems, and to receive results from the processing of the task.

22. The apparatus of claim 21, wherein the control unit is adapted to select the remote system having the highest ranking value among the plurality of remote systems and wherein the control unit adapted to transmit the utility comprises the control unit adapted to transmit a copy of the utility to the plurality of remote systems.

23. The apparatus of claim 19, wherein the control unit is adapted to cause the selected remote system to process the task and receiving results from the processing of the task.

24. The apparatus of claim 19, wherein the control unit is adapted to:
receive, at a controller system, the utility from a client system;
transmit the utility from the controller system to the plurality of remote systems; and
provide the results from the processing of the task to the client system.

25. A method, comprising:
receiving, at a remote system, a utility transmitted by a controller system;
determining a ranking value by executing the received utility, wherein the ranking value is representative of how qualified the remote system may be to at least assist with processing a task requiring completion; and
transmitting the ranking utility to the controller system.

26. The method of claim 25, further comprising receiving at least a portion of the task to process.

27. The method of claim 26, further comprising processing at least the portion of the task and providing one or more results associated the processing to the controller system.

28. A distributed computing system, comprising:
a plurality of remote systems;
a controller system adapted to:
transmit a utility to the plurality of remote systems;
receive ranking values generated by the execution of the utility by the plurality of remote systems; and
determine one or more remote systems suitable to process a task based on the received ranking values.
